(19) United States
(12) Patent Application Publication
(10) Pub. No.: US 2024/0273403 A1
(43) Pub. Date: Aug. 15, 2024

(54) IMAGE FORMATION SYSTEM, IMAGE FORMATION METHOD, AND IMAGE FORMATION PROGRAM FOR ESTIMATING STATE OF IMAGE FORMING DEVICE

(71) Applicant: KYOCERA Document Solutions Inc., Osaka (JP)

(72) Inventor: Naoya MIYAJI, Osaka (JP)

(73) Assignee: KYOCERA Document Solutions Inc., Osaka (JP)

(21) Appl. No.: 18/289,770

(22) PCT Filed: Mar. 24, 2022
(86) PCT No.: PCT/JP2022/014104

§ 371 Date: Nov. 7, 2023

(30) Foreign Application Priority Data
May 14, 2021 (JP) 2021-082550

(51) Int. Cl. G06N 20/00

(52) U.S. Cl. CPC G06N 20/00

(57) ABSTRACT

An image formation system includes a state measuring device that measures a plurality of state quantities of an image forming device, a learning processor that generates a self-organizing map, and a state estimator that estimates a state of the image forming device. The learning processor uses a first learning data set acquired chronologically previously and a second learning data set acquired chronologically subsequently, performs acquisition of first hit counts and generation of a first self-organizing map, and performs acquisition of second hit counts and update of the first self-organizing map to generate a second self-organizing map. In the update, an amount of the update is adjusted based on a product of a Euclidean distance between the first self-organizing map and a self-organizing map to be updated and the first hit count and a product of a Euclidean distance between the second learning data set and the self-organizing map to be updated and the second hit count.

### TECHNICAL FIELD

The present invention relates to image formation systems, image formation methods, and image formation programs capable of estimating the state of an image forming device and particularly relates to a state estimation technique using machine learning.

### BACKGROUND ART

In the maintenance of an image forming apparatus (for example, a printer, a multifunction printer or a multifunction peripheral), it is desirable to accurately estimate the states of internal devices (for example, a photoconductor) thereof. As a solution to this problem, Patent Literature 1 proposes a technique equipped with: a lifetime counter capable of calculating the lifetime of a photosensitive drum to detect the lifetime of the photosensitive drum; and an abutment member detecting device capable of detecting whether or not an abutment member abutting the photosensitive drum 1 is fitted, the technique for changing, based on the detection result of the abutment member detecting device, the method for calculating the lifetime of the photosensitive drum. Patent Literature 1 describes that, according to the above technique, it can be properly detected by the lifetime counter that the photosensitive drum is coming to the end of its lifetime even if any components of the image forming apparatus are added or changed according to market needs after the production.

### CITATION LIST

### Patent Literature

Patent Literature 1: JP-A-2016-57420

### SUMMARY OF INVENTION

### Technical Problem

However, the capability of the above technique does not extend beyond enabling appropriate photoconductor replacement by estimating the coming to the end of the lifetime using the value of the lifetime counter being a single state quantity and has difficulty providing the state of the photoconductor to a serviceman required to take measures, such as the availability of a self-repairing function to be performed by the image forming apparatus itself, according to the state of the photoconductor, and take an appropriate approach according to the state of the photoconductor. Another possible solution to the above problem is measures using machine learning capable of estimating the state of the photoconductor, for example, using a plurality of state quantities. However, there are various types of machine learning and sufficient consideration has not been given to the selection of an appropriate type of artificial intelligence for the operation of the image forming apparatus and the method for applying the artificial intelligence.

The present invention has been made in view of the above circumstances and therefore has an object of providing a technique for efficiently and effectively implementing the estimation of the internal state of an image forming apparatus using machine learning.

A technique improved over the aforementioned techniques is proposed as one aspect of the present invention.

An image formation system according to one aspect of the present invention includes an image forming device, a state measuring device, a learning processor, and a state estimator. The image forming device forms an image. The state measuring device measures a plurality of state quantities of the image forming device. The learning processor generates, based on a learning data set being the plurality of state quantities, a self-organizing map including an input layer and an output layer having a plurality of nodes and for use in classifying the image forming device. The state estimator estimates a state of the image forming device by classifying the image forming device using the self-organizing map. Furthermore, the learning processor uses among the learning data set a first learning data set acquired chronologically previously and a second learning data set acquired chronologically subsequently, executes batch processing using the first learning data set to acquire first hit counts being respective hit counts of the plurality of nodes and generate a first self-organizing map, and then executes batch processing using the first self-organizing map and the second learning data set to acquire second hit counts being respective hit counts of the plurality of nodes, make an update to the first self-organizing map, and thus generate a second self-organizing map. In the update, an amount of the update is adjusted based on a product, in terms of each of the plurality of nodes, of a Euclidean distance between the first self-organizing map and a self-organizing map to be updated and the first hit count and a product, in terms of each of the plurality of nodes, of a Euclidean distance between the second learning data set and the self-organizing map to be updated and the second hit count.

An image formation method according to one aspect of the present invention includes: a state measurement step of measuring a plurality of state quantities of an image forming device that forms an image: a learning processing step of generating, based on a learning data set being the plurality of state quantities, a self-organizing map including an input layer and an output layer having a plurality of nodes and for use in classifying the image forming device; and a state estimation step of estimating a state of the image forming device by classifying the image forming device using the self-organizing map, wherein the learning processing step includes the step of using among the learning data set a first learning data set acquired chronologically previously and a second learning data set acquired chronologically subsequently, performing batch processing using the first learning data set to acquire first hit counts being respective hit counts of the plurality of nodes and generate a first self-organizing map, and then performing batch processing using the first self-organizing map and the second learning data set to acquire second hit counts being respective hit counts of the plurality of nodes, make an update to the first self-organizing map, and thus generate a second self-organizing map, and in the update, an amount of the update is adjusted based on a product, in term of each of the plurality of nodes, of a Euclidean distance between the first self-organizing map and a self-organizing map to be updated and the first hit count and a product, in terms of each of the plurality of nodes, of a Euclidean distance between the second learning data set and the self-organizing map to be updated and the second hit count.

An image formation program according to one aspect of the present invention is an image formation program including a first program and a second program. The first program allows a first processor included in a support computer to function as a learning processor that generates, based on a learning data set being a plurality of state quantities of an image forming device capable of forming an image, a self-organizing map including an input layer and an output layer having a plurality of nodes and for use in classifying the image forming device. The second program allows a second processor included in an image forming apparatus to function as a state estimator that estimates a state of the image forming device by classifying the image forming device using the self-organizing map. The learning processor uses among the learning data set a first learning data set acquired chronologically previously and a second learning data set acquired chronologically subsequently, executes batch processing using the first learning data set to acquire first hit counts being respective hit counts of the plurality of nodes and generate a first self-organizing map, and then executes batch processing using the first self-organizing map and the second learning data set to acquire second hit counts being respective hit counts of the plurality of nodes, make an update to the first self-organizing map, and thus generate a second self-organizing map. In the update, an amount of the update is adjusted based on a product, in terms of each of the plurality of nodes, of a Euclidean distance between the first self-organizing map and a self-organizing map to be updated and the first hit count and a product, in terms of each of the plurality of nodes, of a Euclidean distance between the second learning data set and the self-organizing map to be updated and the second hit count.

### Advantageous Effects of Invention

The present invention enables provision of a technique for efficiently and effectively implementing the estimation of the internal state of an image forming apparatus using machine learning.

### BRIEF DESCRIPTION OF DRAWINGS

FIG. 1 is a block diagram showing a functional configuration of an image formation system 10 according to a first embodiment of the present invention.

FIG. 2 is an illustrative chart showing the configuration of a learning system according the first embodiment.

FIG. 3 is a flowchart showing the contents of self-organizing map generation processing according to a comparative example.

FIG. 4 is an illustrative chart showing the structure of the self-organizing map generation processing according to the comparative example.

FIG. 5 is an illustration showing formulae for use in the self-organizing map generation processing according to the comparative example.

FIG. 6 is a table showing the contents of a self-organizing map according to the comparative example.

FIG. 7 is illustrative graphs showing outlines of self-organizing maps generated in the comparative example.

FIG. 8 is an illustrative chart showing an outline of additional learning according to the first embodiment.

FIG. 9 is a flowchart showing additional learning processing according to the first embodiment.

FIG. 10 is an illustrative chart showing the structure of the additional learning processing according to the first embodiment.

FIG. 11 is an illustration showing formulae for use in the additional learning processing according to the first embodiment.

FIG. 12 is an illustrative graph showing an outline of a self-organizing map generated in the first embodiment.

FIG. 13 is an illustrative chart showing the structure of self-organizing map generation processing according to a second embodiment.

FIG. 14 is a flowchart showing the contents of the self-organizing map generation processing according to the second embodiment.

FIG. 15 is illustrative charts showing high-resolution learning processing and state estimation processing according to the second embodiment.

FIG. 16 is an illustrative chart showing the structure of the self-organizing map generation processing according to the second embodiment.

### DESCRIPTION OF EMBODIMENTS

Hereinafter, a description will be given of an image formation system, an image formation method, and an image formation program according to embodiments as aspects of the present invention, each capable of estimating the state of an image forming device, with reference to the drawings.

Embodiments for practicing the present invention (hereinafter, referred to as “embodiments”) will be described below, with reference to the drawings, in the following order:
A. First Embodiment,
B. Second Embodiment, and
C. Modifications.

### A. First Embodiment

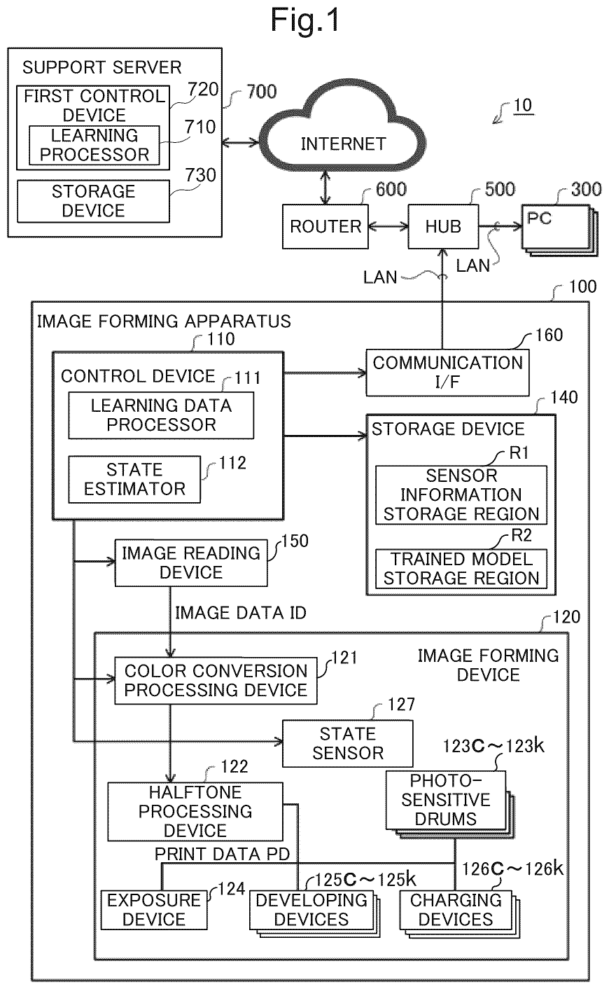

FIG. 1 is a block diagram showing a functional configuration of an image formation system 10 according to a first embodiment of the present invention. The image formation system 10 includes: an image forming apparatus 100 serving as a multifunction peripheral (MFP); and a plurality of personal computers (also referred to simply as PCs) 300. The image formation system 10 is connected to a support server 700 via a hub 500 and a router 600 both constituting a local area network (also referred to simply as a network) LAN and the Internet. The support server 700 includes a learning processor 710 and is also referred to as a support computer.

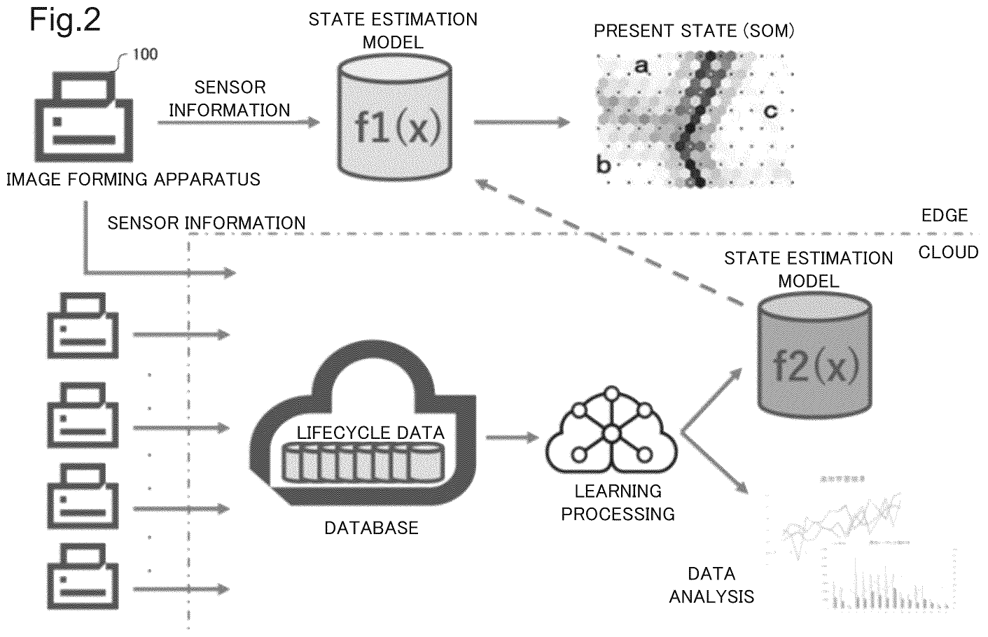

FIG. 2 is an illustrative chart showing the configuration of a learning system 10 according the first embodiment. The image formation system 10 functions as a learning system employing edge computing and is based on a distributed computing environment for collecting sensor information at edges (a plurality of image forming apparatuses 100) as locals and processing and analyzing the sensor information using trained data. On the other hand, the support server 700 is constituted by cloud computing.

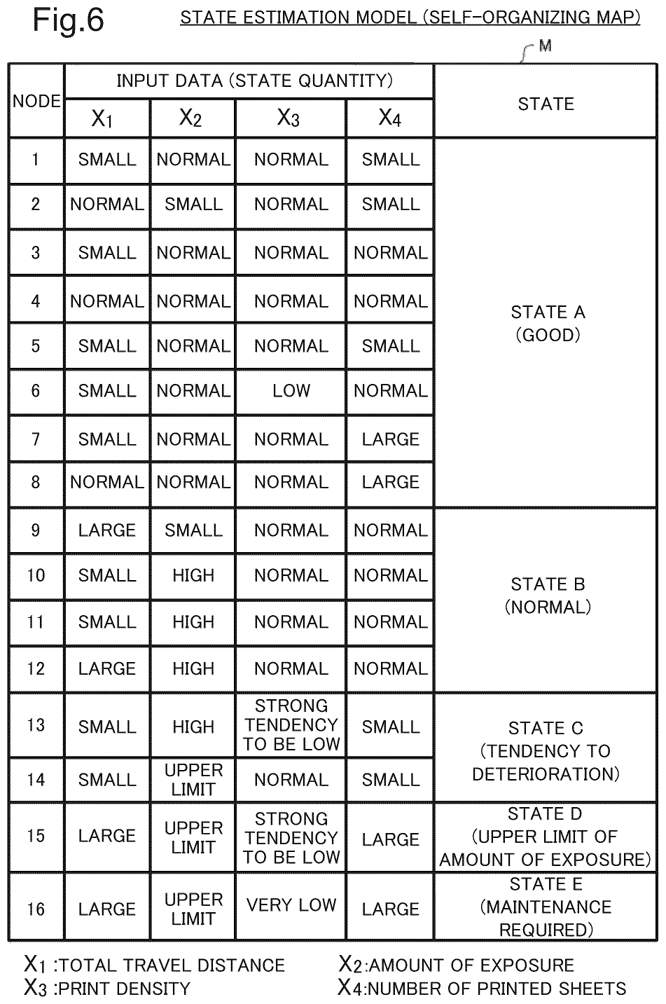

The support server 700 can store as big data sensor information collected at edges (many image forming apparatuses 100). The learning processor 710 of the support server 700 can execute learning processing, for example, using massively parallel software, to generate a self-organizing map (SOM) M as a state estimation model. The support server 700 downloads the state estimation model as trained data to the edges (the many image forming apparatuses 100) (i.e., the many image forming apparatuses 100 receive the state estimation model). The state estimation model is trained data serving as the self-organizing map M (see FIG. 6).

The support server 700 further includes a storage device 730. The storage device 730 is a storage device formed of a hard disk drive, a flash memory or the like, which are non-transitory storage media, and stores control programs (including a second program forming part of an image formation program) for processing to be executed by a first control device 720 and data.

The support server 700 includes the first control device 720. The first control device 720 includes a main storage means, such as a RAM or a ROM, and a control means, such as an MPU (micro processing unit) or a CPU (central processing unit) being an example of the first processor. Furthermore, the first control device 710 has a controller function relating to interfaces, including various I/Os, a USB (universal serial bus), a bus, and other types of hardware, and performs overall control of the support server 700.

The first control device 720 includes the above-described learning processor 710. For example, when the above-described first processor operates according to the above-described first program, the first control device 720 functions as the learning processor 710. The above-described first program and a second program to be described hereinafter constitute the image formation program.

The image forming apparatus 100 includes a control device 110, an image forming device 120, a storage device 140, an image reading device 150, and a communication interface device 160 (also referred to as a communication I/F). The image reading device 150 reads an image from an original document and generates image data ID being digital data on the image. The image forming apparatus 100 is connected via the communication interface device 160 and the LAN to the plurality of computers 300. The communication interface device 160 is configured to be communicable with the support server 700.

The personal computer 300 sends a print job to the image forming apparatus 100 and thus allows the image forming apparatus 100 to perform image formation processing. The print job can be described, for example, in a page-description language (PDL). The control device 110 analyzes the print job described in the page-description language, extracts objects, including a text (characters), images, and vector graphics, contained in the print job, and executes drawing processing and font processing. The print job is also referred to as an image formation job.

The image forming device 120 includes a color conversion processing device 121, a halftone processing device 122, an exposure device 124, photosensitive drums (image carriers) 123c to 123k each formed of an amorphous silicon photoconductor, developing devices 125c to 125k, charging devices 126c to 126k, and a state sensor 127. The color conversion processing device 121 color-converts image data ID as RGB image data or RGB data in a print job to CMYK data. The halftone processing device 122 performs halftone processing on the CMYK data to generate print data PD as halftone data of CMYK. The halftone data represents a formation state of dots formed by respective toners of CMYK and also referred to as dot data.

The state sensor 127 functions as the state measuring device and can measure, as the above-described sensor information, the internal state of the image forming apparatus 100, i.e., the internal temperature and humidity of the image forming apparatus 100, the total number of rotations x1 (an example of a total travel distance) of each of the photosensitive drums 123c to 123k of the image forming device 120, the amount of exposure x2 of the exposure device 124 of the image forming device 120, the patch density x3 (an example of a density of image formation) by the image forming device 120, the number of printed sheets x4 (an example of an amount of image formation), and so on. In this example, the state sensor 127 can acquire, in association with the photosensitive drums 123, an N-dimensional (four-dimensional in this example) feature vector X (x1, x2, x3, x4) as state quantities for a date space being a space for input data. In other words, the state sensor 127 is composed of a thermometer, a hygrometer, optical sensors that measures the respective total amounts of rotations of the photosensitive drums 123c to 123k, and the control device 110 that measures the amount of exposure of the exposure device 124, the patch density by the image forming device 120, and the number of printed sheets.

The storage device 140 is a storage device formed of a hard disk drive, a flash memory or the like, which are non-transitory storage media, and stores control programs (including a first program forming part of the image formation program) for processing to be executed by the control device 110 and data. In this embodiment, the storage device 140 further includes a sensor information storage region R1 and a trained model storage region R2.

The control device (the second control device) 110 includes a main storage means, such as a RAM or a ROM, and a control means, such as an MPU (micro processing unit) or a CPU (central processing unit), being an example of the second processor. Furthermore, the control device 110 has a controller function relating to interfaces, including various I/Os, a USB (universal serial bus), a bus, and other types of hardware, and performs overall control of the image forming apparatus 100.

The control device 110 includes a learning data processor 111 and a state estimator 112. For example, when the above-described second processor operates according to the above-described second program, the control device 110 functions as the learning data processor 111 and the state estimator 112. The learning data processor 111 uploads a feature vector X (x1, x2, x3, x4) acquired from the state sensor 127 to the support server 700. The state estimator 112 can implement the estimation of the internal state of the image forming apparatus 100 through clustering processing using a self-organizing map M downloaded from the support server 700. The function to generate a self-organizing map can be implemented on the support server 700, for example, using a tool or a library, such as Python or Tensorflow.

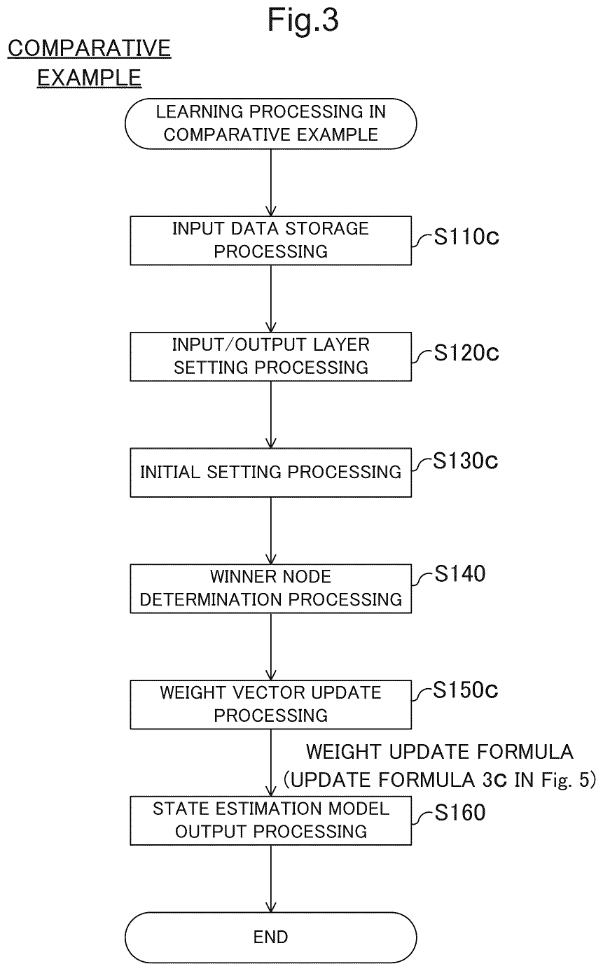

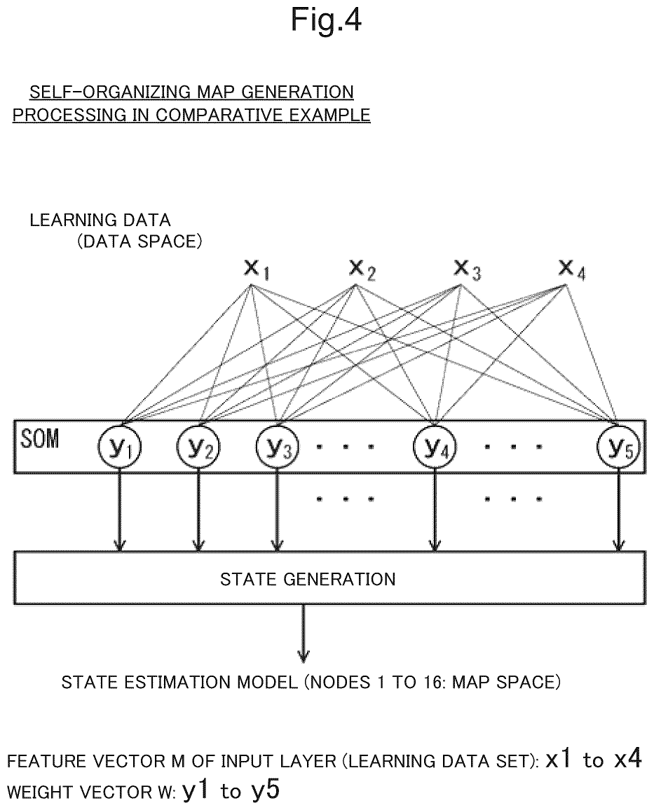

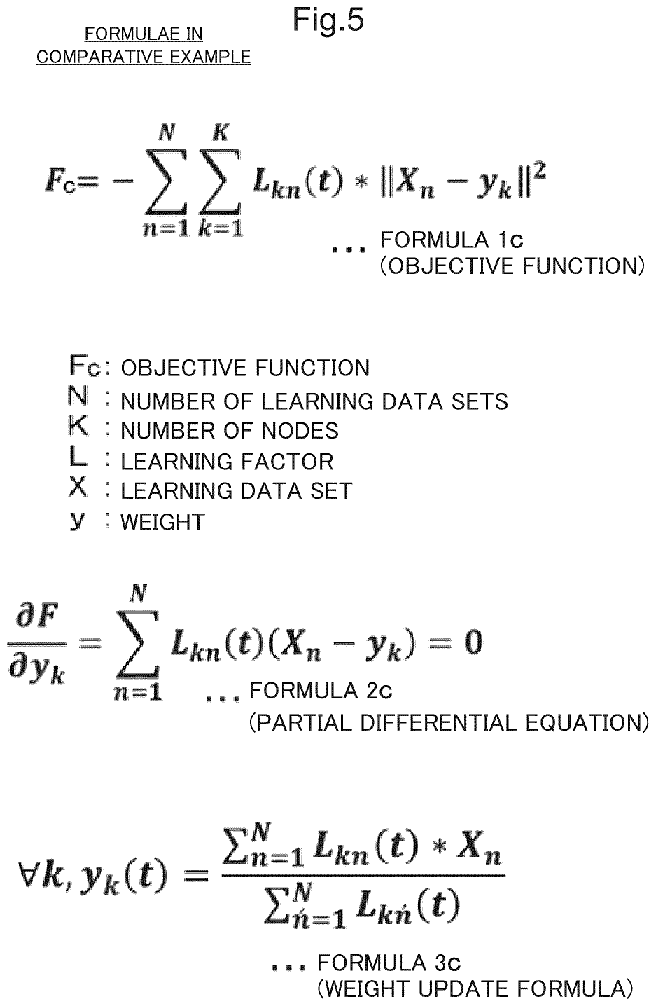

FIG. 3 is a flowchart showing the contents of self-organizing map generation processing according to a comparative example. FIG. 4 is an illustrative chart showing the structure of the self-organizing map generation processing according to the comparative example. FIG. 5 is a table showing the contents of a self-organizing map according to the comparative example. The self-organizing map (SOM) is an unsupervised neural network algorithm proposed by T. Kohonen and a data analyzing method for non-linearly mapping high-dimensional data, for example, onto a two-dimensional plane. Since this algorithm is an unsupervised neural network algorithm, it has the advantage of being easily implementable without preparing any teacher.

In step S110c, the image formation system 10 performs input data storage processing. In the input data storage processing, the learning data processor 111 of the control device 110 included in the image forming apparatus 100 uses the state sensor 127 at first intervals (for example, weekly) as specified intervals to acquire a plurality of state quantities comprising a feature vector X (x1, x2, x3, x4) and stores them in the sensor information storage region R1 of the storage device 140.

The learning data processor 111 reads from the sensor information storage region R1 the plurality of state quantities comprising the feature vector X at second intervals (for example, monthly) as specified intervals longer than the first intervals and uploads them to the support server 700. When the learning processor 710 determines that respective pluralities of state quantities comprising respective feature vectors X collected from a plurality of image forming apparatuses 100 have reached a preset amount of learning data, i.e., a sufficient amount of learning data for learning for the generation of a self-organizing map, it allows the processing to proceed to step S120c.

In step S120c, the learning processor 710 of the support server 700 executes input/output layer setting processing. In this example, suppose that the learning processor 710 sets, in terms of the plurality of state quantities, a feature vector X as an input layer of a self-organizing map and sets an output layer having 16 nodes specifying different points in a map space being a space to be mapped from the input layer. In this example, the learning processor 710 sets a 4×4 two-dimensional map as the map space.

As shown in FIG. 4, a self-organizing map is a two-layered neural network composed of an input layer and an output layer. Each node of the output layer has an N-dimensional (four-dimensional in this example) weight vector Y (y1, y2, y3, y4) linked with every variable (x1, x2, x3, x4) of an N-dimensional feature vector of the input layer.

In step S130c, the learning processor 710 executes initial setting processing. In the initial setting processing, the learning processor 710 sets a weight vector Y (v1, v2, y3, y4), for example, using random numbers. Although in this example initial values of a weight Y for each link are set using random numbers, the initial values of the weight Y for each link may be set, from the viewpoint of learning efficiency, for example, using past trained data on a similar apparatus model or data set by a different analyzing method. The weight vector Y is a vector to be updated through learning processing.

In step S140, the learning processor 710 executes winner node determination processing. In the winner node determination processing, the learning processor 710 determines a winner node using as an input data set each of feature vectors (x1, x2, x3, x4) being learning data sets collected from the plurality of image forming apparatuses 100. The winner node is selected as a node having a weight vector Y nearest in Euclidean distance to the feature vector X (x1, x2, x3, x4) of the input data set.

In step S150c, the learning processor 710 executes weight vector update processing. In the weight vector update processing, the learning processor 710 updates, using a predetermined update formula, the weight vector Y of the winner node and the weight vectors Y of neighbor nodes neighboring the winner node and the update is repeated predetermined times using all the learning data sets.

The update is performed by bringing the weight vector Y of the winner node and the weight vectors Y of the neighbor nodes close to the feature vector X (x1, x2, x3, x4) of the input data set. In terms of the amount of the update, it is configured so that the weight vector Y of the winner node reaches the largest amount of the update and the amount of the update of the weight vector Y of the node nearer the winner node becomes closer to the amount of the update of the weight vector Y of the winner node. The winner node and the neighbor nodes are also referred to as to-be-updated nodes.

FIG. 5 is an illustration showing formulae for use in the self-organizing map generation processing according to the comparative example. Formula 1c is an objective function Fc for use in an algorithm for self-organizing mapping. The self-organizing mapping is processed to maximize the objective function Fc having a negative value. In other words, the self-organizing mapping is processed to reduce the Euclidean distance between the feature vector X of an input data set and each of to-be-updated nodes.

Formula 2c is a partial differential equation derived by partially differentiating Formula 1c with respect to the weight vector Y. Formula 3c is an update formula derived as a solution of the partial differential equation (Formula 2c). The update formula 3c is an equation for updating the weight vector Y of the to-be-updated node to bring it close to the feature vector X of the input data set. These winner node determination processing (step S140) and weight vector update processing (step S150) are executed by batch processing, which enables reduction in total throughput and stable state estimation as compared to online learning.

In step S160, the learning processor 710 outputs a state estimation model. The state estimation model is constituted as weight vectors Y of all nodes (16 nodes in this example) of the output layer. The support server 700 notifies the plurality of image forming apparatuses 100 that a trained state estimation model is available, and downloads, in response to requests from the image forming apparatuses 100, the state estimation model to the image forming apparatuses 100. The plurality of image forming apparatuses 100 store the state estimation model in the trained model storage region R2 of the storage device 140.

FIG. 6 is a table showing the contents of a self-organizing map according to the comparative example. In this example, the state estimation model M (the self-organizing map) is configured as a table showing, for each node of the output layer, a plurality of state quantities of the photosensitive drums 123 (an input data set) and an estimated state of the photosensitive drums 123. In the state estimation model M, the words “Small”, “Normal”, “Low”, and so on regarding the input data sets are expressed for clarification of explanation and, actually, a normalized value from 0 to 1 is entered in each of these cells.

The state estimator 112 included in each of the control devices 110 of the plurality of image forming apparatuses 100 can use the state estimation model M stored in the trained model storage region R2 to estimate (analyze) the state of the photosensitive drums 123 based on a latest feature vector X (x1, x2, x3, x4) which is a plurality of state quantities, i.e., the total travel distance x1, the amount of exposure x2, the print density x3, and the number of printed sheets x4, acquired using the state sensor 127. Specifically, for example, when the travel distance x1 is large, the amount of exposure x2 is small, and the print density x3 and the number of printed sheets x4 are normal, the state estimator 112 can determine that these state quantities fit the node 9 and the state of the photosensitive drums 123 is “Normal”.

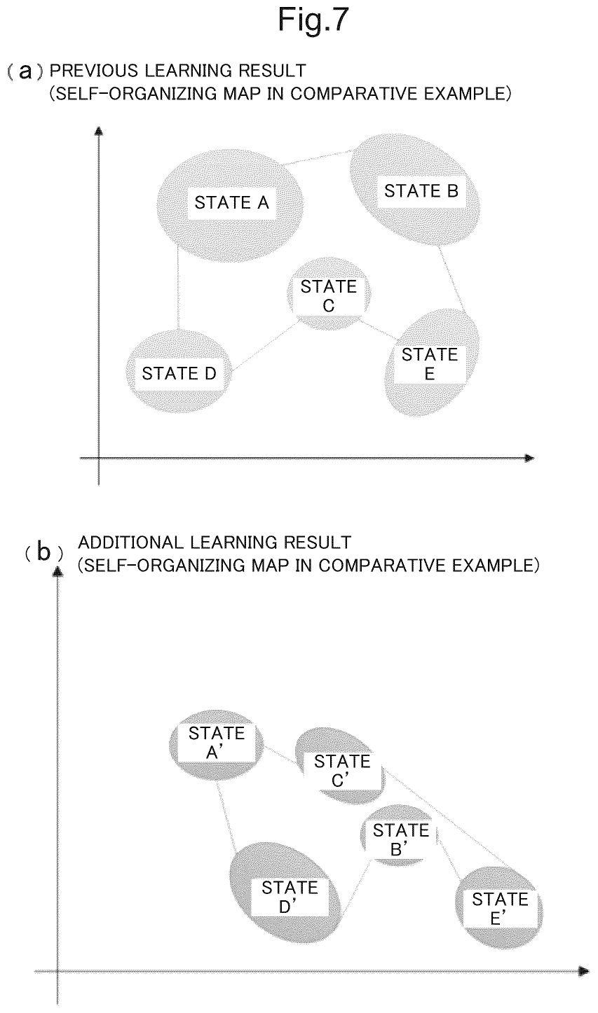

FIG. 7 is illustrative graphs showing outlines of self-organizing maps generated in the comparative example. FIG. 7(a) shows what is a self-organizing map as a result of learning according to the comparative example. FIG. 7(a) schematically shows the state estimation model M as an image in the form of a two-dimensional map. In this example, through clustering by the learning processor 710, the nodes 1 to 8 of the state estimation model M are classified into a cluster of State A, the nodes 9 to 12 thereof are classified into a cluster of State B, the nodes 13 and 14 thereof are classified into a cluster of State C, the node 15 thereof is classified into a cluster of State D, and the node 16 thereof is classified into a cluster of State E.

FIG. 7(b) shows what is a self-organizing map as a result of additional learning according to the comparative example. The additional learning according to the comparative example is learning processing executed, using a weight vector Y from a state estimation model M of a previous learning result as initial values of the weight vector Y for learning, according to the flowchart of the batch learning processing (FIG. 3) according to the comparative example. As seen from a clustering result of FIG. 7(b), the phases of the clusters largely change from the previous learning result to change the relative position between the clusters. The reason for this is that the previous learning result does not contribute to the weight update formula 3c during the additional learning. To solve this problem, the inventor of the present application has created a novel structure described below.

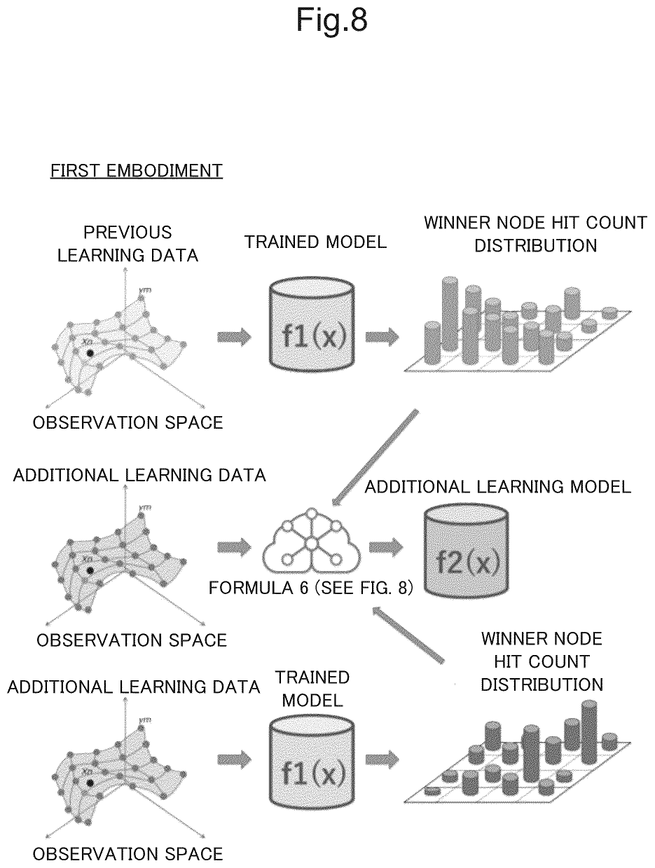

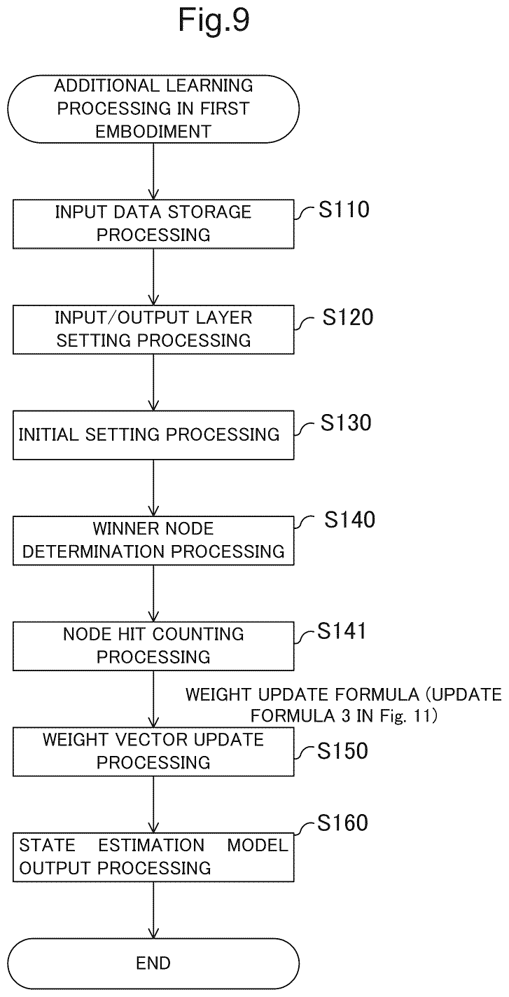

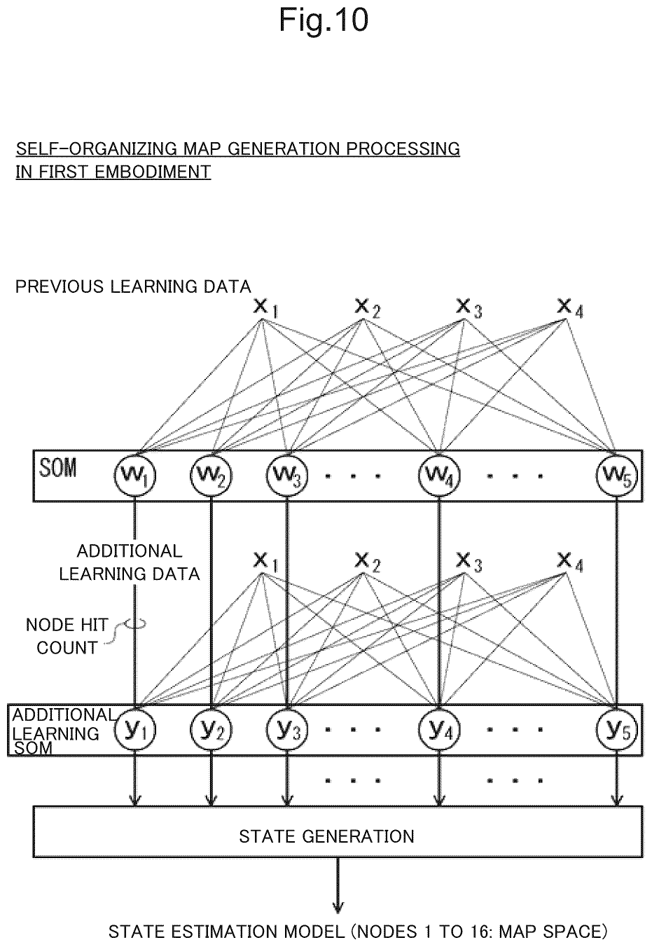

FIG. 8 is an illustrative chart showing an outline of additional learning processing according to the first embodiment. FIG. 9 is a flowchart showing additional learning processing according to the first embodiment. FIG. 10 is an illustrative chart showing the structure of the additional learning processing according to the first embodiment. The additional learning processing according to the first embodiment has been created to take the number of times when each node has become a winner, i.e., the node hit count of each node, as an index indicating the amount of learning and weight each node based on its node hit count.

In step S110, the learning processor 710 acquires, from each of the plurality of image forming apparatuses 100, a plurality of state quantities comprising a feature vector X (x1, x2, x3, x4) as a second learning data set acquired chronologically subsequently after a first learning data set (acquired chronologically previously) for use in the generation of a state estimation model M. The state estimation model M generated by previous learning processing is also referred to as a first self-organizing map.

In step S120, the learning processor 710 executes input/output layer setting processing. In the input/output layer setting processing, the same configuration as in the previous learning is adopted in principle. However, depending on a result of sensitivity analysis, a low-sensitivity variable of the feature vector X (x1, x2, x3, x4) may be deleted or a new variable may be added or substituted.

In step S130, the learning processor 710 executes initial setting processing. In the initial setting processing, the learning processor 710 sets the state estimation model M as an initial state in principle. However, the learning processor 710 may change the contents of the initial settings according to any change, such as the deletion, addition or substitution of a variable.

In step S140, the learning processor 710 executes winner node determination processing. The contents of the winner node determination processing are the same as those of the processing in the comparative example. In step S141, unlike the comparative example, the learning processor 710 executes node hit counting processing. In the node hit counting processing, the learning processor 710 counts, for each node during batch processing, the number of times when the node has become a winner.

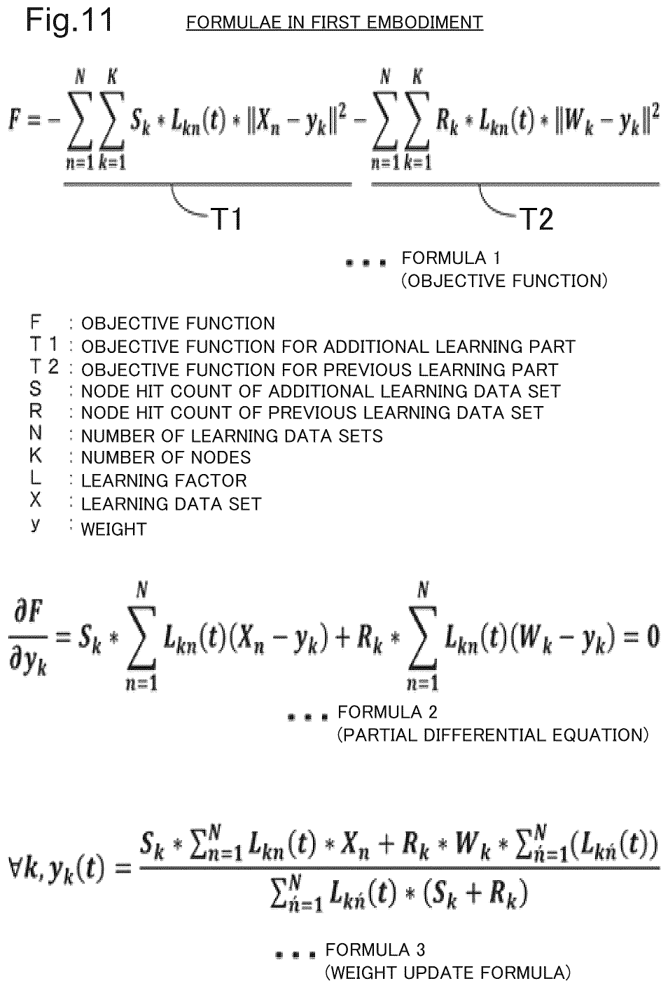

In step S150, the learning processor 710 executes weight vector update processing. However, the vector update processing (step S150) according to the first embodiment is different from the weight vector update processing (step S150c) according to the comparative example in that the weight update formula is changed from Formula 3c (see FIG. 7) to Formula 3 (see FIG. 11).

FIG. 11 is an illustration showing formulae for use in the additional learning processing according to the first embodiment. Formula 1 is an objective function F of an algorithm for self-organizing mapping in the additional learning. The first term T1 of the objective function F represents an objective function of a part corresponding to additional learning only, i.e., a contribution of the additional learning to the objective function F. The second term T2 of the objective function F represents an objective function of a part corresponding to previous learning only, i.e., a contribution of the previous learning to the objective function F.

The first term T1 of the objective function F contains, in terms of each node of a self-organizing map to be updated, a product of the node hit count S regarding an additional learning data set (a second learning data set) and the Euclidean distance between the additional learning data set and the self-organizing map to be updated. On the other hand, the second term T2 of the objective function F contains, in terms of each node of the self-organizing map to be updated, a product of the node hit count R regarding a previous learning data set (a first learning data set) and the Euclidean distance between the previously trained self-organizing map and the self-organizing map to be updated.

The node hit count R regarding a previous learning data set is also referred to as a first hit count. The node hit count S regarding an additional learning data set is also referred to as a second hit count. Therefore, the amount of the update of the weight vector Y of each to-be-updated node is adjusted by the first hit count, the second hit count, and the previous learning data set.

Formula 2 is a partial differential equation derived by partially differentiating Formula 1 with respect to the weight vector Y. Formula 3 is an update formula derived as a solution of the partial differential equation (Formula 2). The update formula 3 is an equation for updating the weight vector Y of each to-be-updated node to bring it close to the feature vector X of the input data set while considering, for each node, ratios of contribution based on the amount of learning of the additional learning data set and the amount of learning of the previous learning data set.

Formula 3 can also be interpreted as follows. According to Formula 3, the ratios of contribution of the additional learning data set X and the trained weight vector w to the weight vector Y can be adjusted based on the node hit counts S and R. Specifically, it can be seen that when the node hit count R regarding the previous learning data set is 0, i.e., in a situation at initial learning where previous learning is not performed, the node hit count S during learning is cancelled, Formula 3 takes the same form as the update formula of Formula 3c in the comparative example.

On the other hand, when the node hit count during additional learning sharply increases, this means, according to Formula 3, that the ratio of contribution of the weight vector w during previous learning decreases and a self-organizing model is rebuilt. According to Formula 3, when the node hit count during each additional learning increases by a certain number A, the ratio between the node hit count S during additional learning and the node hit count R during previous learning is A: A and, therefore, the ratio of contribution of the additional learning data set is ½ (=A/2A). The ratio between the node hit counts during the next learning, i.e., the third round of learning, is A:2A and, therefore, the ratio of contribution is ⅓ (=A/3A). In this manner, the ratio of contribution to an additional learning data set gradually decreases. In addition, since additional learning data set X does not contain a previously trained data set, additional learning can be implemented using a data set containing the additional learning data set only. Therefore, the bloating of the learning data set and the increase in processing time for the additional learning can be prevented.

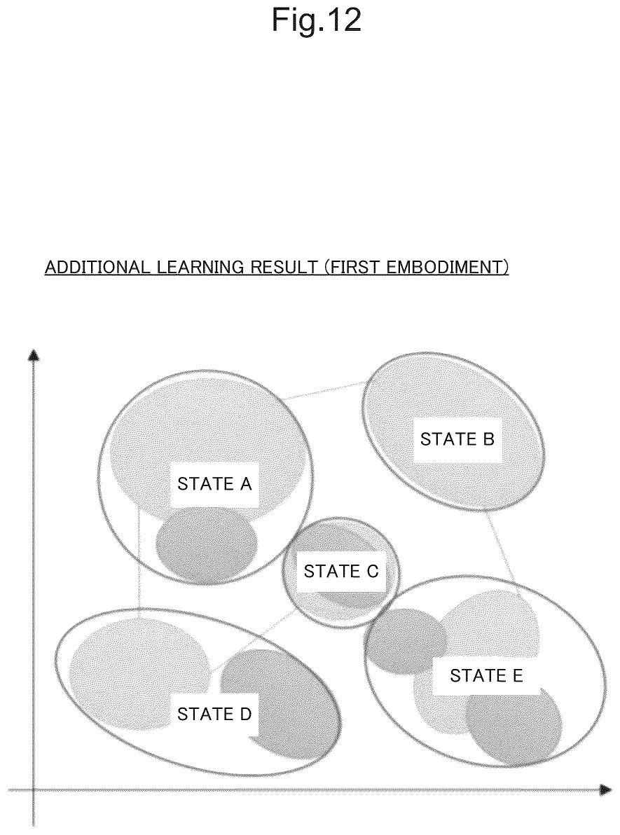

FIG. 12 is an illustrative graph showing an outline of a self-organizing map generated in the first embodiment. In this example, through clustering by the learning processor 710, the clusters of the state estimation model M learn while maintaining their phases relative to each other and expands their regions. Thus, changes in the self-organizing map due to additional learning can be easily analyzed. A state estimation model Ma generated by additional learning processing is also referred to as a second self-organizing map.

Since, as thus far described, the image forming apparatus 100 according to the first embodiment performs additional learning processing by taking the number of times when each node has become a winner, i.e., the node hit count of each node, as an index indicating the amount of learning and weighting each node based on its node hit count, the clusters of the state estimation model M can learn while maintaining their phases relative to each other. Thus, changes in the self-organizing map due to additional learning can be easily analyzed.

Furthermore, since the image forming apparatus 100 according to the first embodiment can perform additional learning using a data set containing an additional learning data set only, the bloating of the learning data set and an excessively long processing time for the additional learning can be prevented as compared to the manner of relearning from the beginning. In addition, since the image forming apparatus 100 according to the first embodiment can update the weight while maintaining the phase relationships of nodes, feature analysis (such as transition of weight parameters of nodes) can be efficiently performed by additionally learning a huge amount of market data as learning data. Moreover, since the phase relationships of nodes are maintained, there is no need to label the nodes again after additional learning.

### B. Second Embodiment

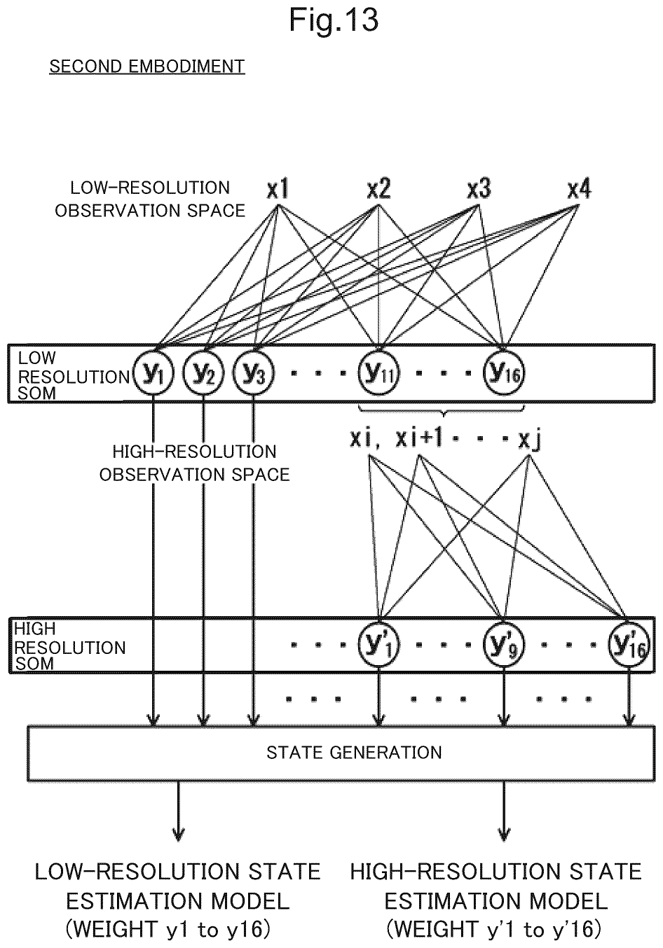

FIG. 13 is an illustrative chart showing the structure of self-organizing map generation processing according to a second embodiment. Unlike general self-organizing map generation processing, self-organizing map generation processing according to the second embodiment can generate a plurality of state estimation models (two state estimation models in this example) by a plurality of stages of clustering comprising low-resolution clustering for generating a low-resolution state estimation model L and high-resolution clustering for generating a high-resolution state estimation model H.

In the low-resolution clustering, the learning processor 710 executes the same processing as the self-organizing map generation processing according to the first embodiment. Thus, the learning processor 710 can generate a low-resolution state estimation model L using the objective function Fc. The low-resolution state estimation model L (y1 to y16) is a learning model identical to the state estimation model M (see FIG. 6) generated by the self-organizing map generation processing according to the comparative example. In the state estimation model M, as seen from FIG. 6, the nodes 1 to 12 are classified as State A (Good) or State B (Normal) and the nodes 13 to 16 are classified as abnormality (State C to State E).

In the high-resolution clustering, the learning processor 710 extracts only feature vectors X (xi, xi+1, . . . xj) being input data sets on a plurality of image forming apparatuses 100 corresponding to (i.e., becoming winners as or getting hits as) the nodes 13 to 16 classified as abnormality. The learning processor 710 executes clustering using the extracted input data sets and newly using as a map space a 4×4 (16 nodes in total) two-dimensional map. Thus, the learning processor 710 can reclassify at high resolution the abnormalities of the nodes 13 to 16 classified into four categories using the objective function Fc to generate a high-resolution state estimation model H (v′1 to y′16).

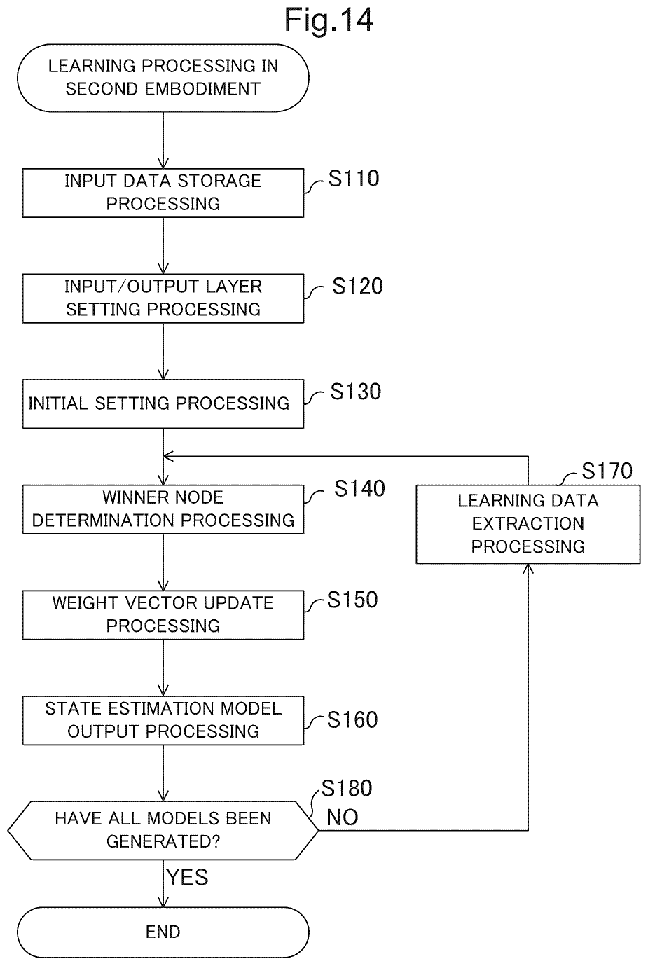

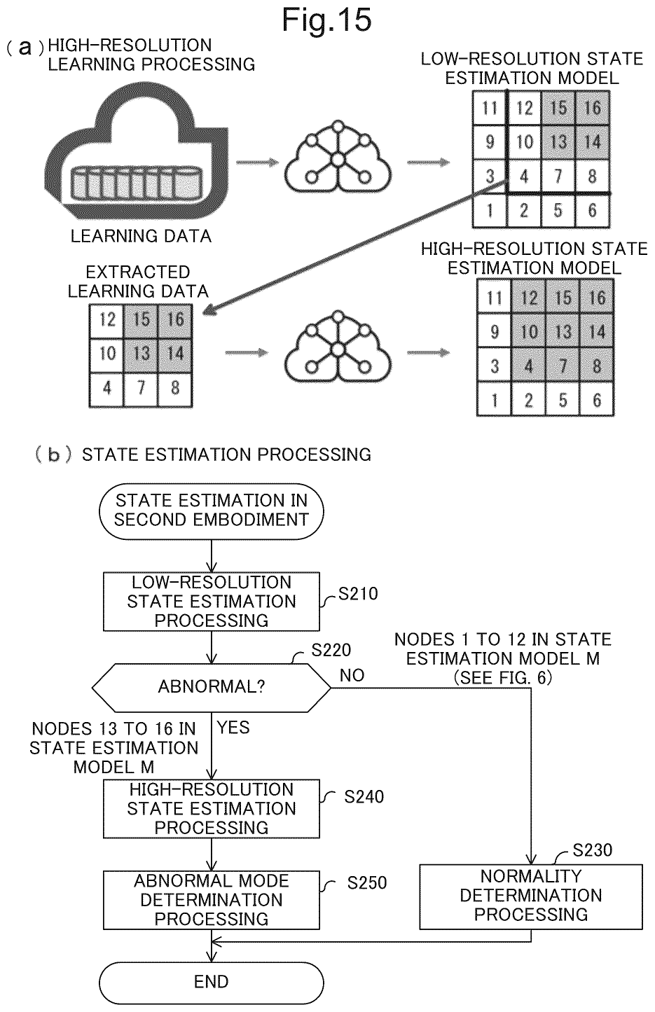

FIG. 14 is a flowchart showing the contents of the self-organizing map generation processing according to the second embodiment. FIG. 15(a) is an illustrative chart showing high-resolution learning processing according to the second embodiment. The self-organizing map generation processing according to the second embodiment is different, from the self-organizing map generation processing according to the first embodiment, in that it generates a plurality of state estimation models (two state estimation models in this example) by a plurality of stages of clustering comprising low-resolution clustering and high-resolution clustering.

In the self-organizing map generation processing according to the second embodiment, through a first round of processing from steps S110 to S130 and a first round of processing from steps S140 to S160, a state estimation model L (v1 to y16, see FIG. 15(a)) at low resolution (normal resolution) is generated in the same manner as in the self-organizing map generation processing according to the first embodiment. Prior to a second round of processing from steps S140 to S160, the learning processor 710 executes learning data extraction processing (step S170). In the learning data extraction processing, the learning processor 710 extracts learning data sets corresponding to nodes meeting a predetermined standard (classification as abnormality in this example) and learning data sets corresponding to nodes neighboring the above nodes.

Specifically, the learning processor 710 extracts learning data sets on the nodes (nodes 13 to 16) classified as abnormality in the low-resolution state estimation model L (identical to the state estimation model M) and learning data sets on nodes 4, 7, 8, 10, and 12 neighboring the above nodes. Using the learning data sets extracted in the above manner and using a 4×4 (16 nodes in total) two-dimensional map, with the low-resolution state estimation model L as initial values, the learning processor 710 generates a high-resolution state estimation model H (y′1 to y′16, see FIG. 15) in the same manner as in the self-organizing map generation processing according to the first embodiment and then ends the processing (step S180).

The learning processor 710 notifies all the plurality of image forming apparatuses 100 that the low-resolution state estimation model L and the high-resolution state estimation model H have been generated. The learning processor 710 downloads, in response to requests from the plurality of image forming apparatuses 100, the low-resolution state estimation model L and the high-resolution state estimation model H to the image forming apparatuses 100. The high-resolution state estimation model H is built so that the nodes belonging to some of the categories in the low-resolution state estimation model L have a high resolution. Furthermore, the learning processor 710 may be configured to be capable of generating an ultra-high-resolution state estimation model UH built so that nodes belonging to some of the categories in the high-resolution state estimation model H have a higher resolution.

FIG. 15(b) is an illustrative chart showing state estimation processing according to the second embodiment. In step S210, the state estimator 112 of the control device 110 included in each of the plurality of image forming apparatuses 100 executes low-resolution state estimation processing. In the low-resolution state estimation processing, the state estimator 112 uses the low-resolution state estimation model L downloaded and stored in the trained model storage region R2 to estimate the state of the photosensitive drums 123 based on a latest feature vector X (x1, x2, x3, x4) acquired using the state sensor 127 (primary analysis).

In step S220, the state estimator 112 determines whether or not the result of the primary analysis corresponds to normality (i.e., good or normal). When the state is determined to fall into normality, i.e., when the state is determined to correspond to the nodes 1 to 12 in the state estimation model M (see FIG. 6), the state estimator 112 allows the processing to proceed to step S230, in which the user is notified, through a display or the like (not shown), that the state falls into normality.

On the other hand, when the state is determined not to fall into normality, i.e., when the state is determined to correspond to the nodes 13 to 16 which are nodes other than the nodes 1 to 12 in the low-resolution state estimation model L, the state estimator 112 allows the processing to proceed to step S240.

In step S240, the state estimator 112 executes high-resolution state estimation processing. In the high-resolution state estimation processing, the state estimator 112 uses the high-resolution state estimation model H downloaded and stored in the trained model storage region R2 to estimate the state of the photosensitive drums 123 based on a latest feature vector X (x1, x2, x3, x4) acquired using the state sensor 127 (secondary analysis). Thus, the state estimator 112 can determine how is the abnormal mode, i.e., a more specific state of abnormality (abnormal mode) (step S250) and notify the user of the details of the abnormality through a display or the like (not shown). The high-resolution state estimation model H is also referred to as a first high-resolution self-organizing map.

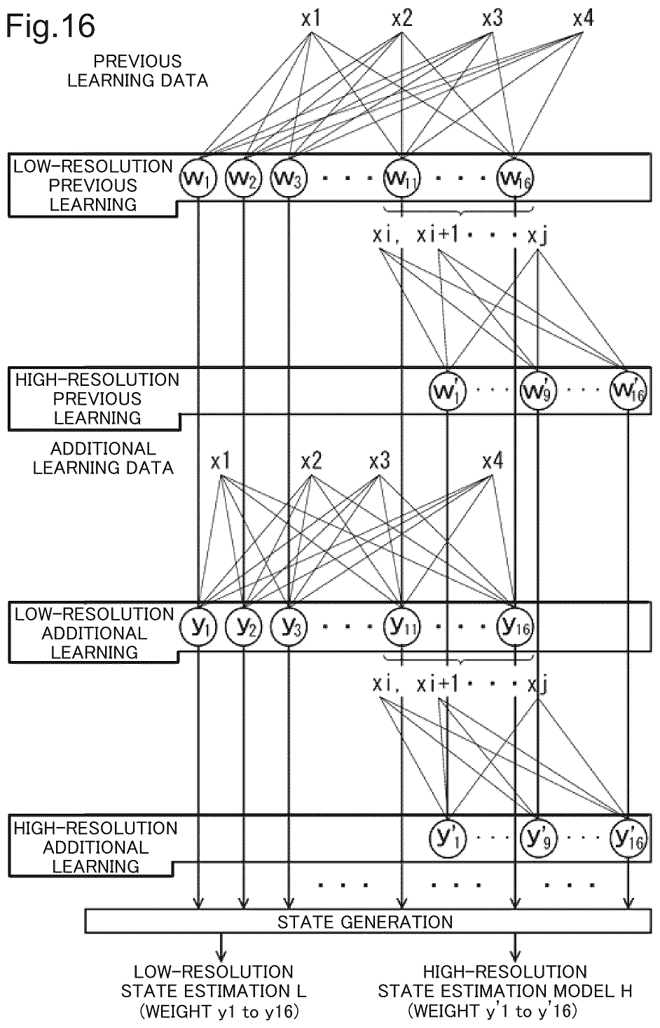

FIG. 16 is an illustrative chart showing the structure of the self-organizing map generation processing according to the second embodiment. The learning processor 710 performs, using the node hit count S regarding an additional learning data set and the node hit count R regarding a previous learning data set, additional learning on the low-resolution state estimation model L and the high-resolution state estimation model H, on each of which the additional learning is performed using the objective function F in the same manner as in the first embodiment. A model generated by the execution of additional learning on the high-resolution state estimation model H is also referred to as a second high-resolution self-organizing map.

In generating a high-resolution state estimation model H using a low-resolution state estimation model L, the objective function Tc in the comparative example may be used. This is advantageous in that the learning processor 710 can effectively use a second learning data set acquired chronologically subsequently to accelerate the classification of abnormalities increased due to an increase in operational life. Alternatively, the objective function F may be used also in generating a high-resolution state estimation model H using a low-resolution state estimation model L. This is advantageous in that the learning processor 710 can easily analyze changes from clustering based on the low-resolution state estimation model L to the high-resolution state estimation model H. In addition, by correcting the node hit count, the classification method can be adjusted in an appropriate position between both the models.

As thus far described, the image forming apparatus 100 according to the second embodiment performs multiple rounds of learning using respective learning models having the same number of nodes while changing extracted input data sets by narrowing them in terms of specific classification and, thereby, can implement a plurality of types of models having different resolutions while being common as an inference execution model. Thus, the image forming apparatus 100 according to the second embodiment enables model implementation with saved resources and broad and highly accurate state estimation.

### C. Modifications:

The present invention is not limited to the above embodiments and can also be implemented as the following modifications.

Modification 1: Although in the above embodiments the learning data processor 111 uploads a learning data set acquired from the state sensor 127 to the support server 700 at specific intervals (the second intervals in the first embodiment), a learning data set may be uploaded, for example, upon each exchange of components, such as exchange of photosensitive drums, for example, before and after the exchange of components.

Modification 2: Although in the above embodiments the image formation system 10 estimates the state of photosensitive drums, the target to be estimated is not limited to photosensitive drums and the image formation system 10 may perform, for example, at least one of state estimations including the state estimation of any of the other components of the image forming device 120 and the state estimation of the entire image forming device 120.

1. An image formation system comprising:
an image forming device that forms an image:
a state measuring device that measures a plurality of state quantities of the image forming device:
a learning processor that generates, based on a learning data set being the plurality of state quantities, a self-organizing map including an input layer and an output layer having a plurality of nodes and for use in classifying the image forming device; and
a state estimator that estimates a state of the image forming device by classifying the image forming device using the self-organizing map,
wherein the learning processor uses among the learning data set a first learning data set acquired chronologically previously and a second learning data set acquired chronologically subsequently, executes batch processing using the first learning data set to acquire first hit counts being respective hit counts of the plurality of nodes and generate a first self-organizing map, and then executes batch processing using the first self-organizing map and the second learning data set to acquire second hit counts being respective hit counts of the plurality of nodes, make an update to the first self-organizing map, and thus generate a second self-organizing map, and
in the update, an amount of the update is adjusted based on a product, in terms of each of the plurality of nodes, of a Euclidean distance between the first self-organizing map and a self-organizing map to be updated and the first hit count and a product, in terms of each of the plurality of nodes, of a Euclidean distance between the second learning data set and the self-organizing map to be updated and the second hit count.

2. The image formation system according to claim 1, comprising:
a support computer comprising the learning processor and capable of communication; and
a plurality of image forming apparatuses each of which comprises the image forming device, the state measuring device, and a communication interface capable of communication with the support computer, sends the learning data set being the plurality of state quantities through the communication interface to the support computer, and receives the second self-organizing map from the support computer.

3. The image formation system according to claim 2, wherein each of the image forming apparatuses sends the learning data set through the communication interface to the support computer (i) at predetermined intervals or (ii) each time when a component included in the image forming device and serving as a target to be estimated in term of state is exchanged.

4. The image formation system according to claim 2, wherein the support computer is constituted by cloud computing.

5. The image formation system according to claim 1, wherein the learning processor executes the update to maximize an objective function having a negative value containing the product of the Euclidean distance between the first self-organizing map and the self-organizing map to be updated and the first hit count and the product of the Euclidean distance between the second learning data set and the self-organizing map to be updated and the second hit count.

6. The image formation system according to claim 1, wherein the learning processor uses learning data sets corresponding to one or some of the plurality of nodes in the first self-organizing map to generate a first high-resolution self-organizing map partially higher in resolution than the first self-organizing map and executes the update to the first high-resolution self-organizing map to generate a second high-resolution self-organizing map.

7. The image formation system according to claim 1, wherein
the plurality of state quantities include a total travel distance of the photosensitive drum, an amount of exposure, a density of image formation, and an amount of image formation, and
the state estimator estimates the state of the photosensitive drum.

8. An image formation method comprising:
a state measurement step of measuring a plurality of state quantities of an image forming device that forms an image:
a learning processing step of generating, based on a learning data set being the plurality of state quantities, a self-organizing map including an input layer and an output layer having a plurality of nodes and for use in classifying the image forming device; and
a state estimation step of estimating a state of the image forming device by classifying the image forming device using the self-organizing,
wherein the learning processing step comprises the step of using among the learning data set a first learning data set acquired chronologically previously and a second learning data set acquired chronologically subsequently, performing batch processing using the first learning data set to acquire first hit counts being respective hit counts of the plurality of nodes and generate a first self-organizing map, and then performing batch processing using the first self-organizing map and the second learning data set to acquire second hit counts being respective hit counts of the plurality of nodes, make an update to the first self-organizing map, and thus generate a second self-organizing map, and
in the update, an amount of the update is adjusted based on a product, in terms of each of the plurality of nodes, of a Euclidean distance between the first self-organizing map and a self-organizing map to be updated and the first hit count and a product, in terms of each of the plurality of nodes, of a Euclidean distance between the second learning data set and the self-organizing map to be updated and the second hit count.

9. An image formation program comprising a first program and a second program,
the first program allowing a first processor included in a support computer to function as a learning processor that generates, based a learning data set being a plurality of state quantities of an image forming device capable of forming an image, a self-organizing map including an input layer and an output layer having a plurality of nodes and for use in classifying the image forming device,
the second program allowing a second processor included in an image forming apparatus to function as a state estimator that estimates a state of the image forming device by classifying the image forming device using the self-organizing map,
wherein the learning processor uses among the learning data set a first learning data set acquired chronologically previously and a second learning data set acquired chronologically subsequently, executes batch processing using the first learning data set to acquire first hit counts being respective hit counts of the plurality of nodes and generate a first self-organizing map, and then executes batch processing using the first self-organizing map and the second learning data set to acquire second hit counts being respective hit counts of the plurality of nodes, make an update to the first self-organizing map, and thus generate a second self-organizing map, and
in the update, an amount of the update is adjusted based on a product, in terms of each of the plurality of nodes, of a Euclidean distance between the first self-organizing map and a self-organizing map to be updated and the first hit count and a product, in terms of each of the plurality of nodes, of a Euclidean distance between the second learning data set and the self-organizing map to be updated and the second hit count.
